(19) United States
(12) Patent Application Publication
(10) Pub. No.: US 2025/0271273 A1
(43) Pub. Date: Aug. 28, 2025

(54) METHOD FOR MONITORING WHETHER A VEHICLE HAS CROSSED A BOUNDARY OF A ZONE IN WHICH THE VEHICLE CAN DRIVE, AND DRIVER ASSISTANCE SYSTEM

(71) Applicant: Continental Autonomous Mobility Germany GmbH, Ingolstadt (DE)

(72) Inventors: Qiangqiang Zhu, Langen (DE); Moritz Schrader, Frankfurt am Main (DE); Stefan Hahn, Hösbach (DE)

(73) Assignee: Continental Autonomous Mobility Germany GmbH, Ingolstadt (DE)

(21) Appl. No.: 18/858,347

(22) PCT Filed: Mar. 29, 2023
(86) PCT No.: PCT/DE2023/200068

§ 371 Date: Oct. 21, 2024

(30) Foreign Application Priority Data
Apr. 19, 2022 (DE) 10 2022 203 827.4

(51) Int. Cl. G01C 21/28; B60W 30/10

(52) U.S. Cl. CPC G01C 21/28; B60W 30/10; B60W 2552/53

(57) ABSTRACT

The present disclosure relates to a computer-implemented method for monitoring whether a vehicle traveling along a trajectory has crossed a boundary of a driveable area, by means of a rotation direction determination.

### CROSS-REFERENCE TO RELATED APPLICATIONS

The present application is a National Stage Application under 35 U.S.C. § 371 of International Patent Application No. PCT/DE2023/200068 filed on Mar. 29, 2023, and claims priority from German Patent Application No. 10 2022 203 827.4 filed on Apr. 19, 2022, in the German Patent and Trademark Office, the disclosures of which are herein incorporated by reference in their entireties.

### TECHNICAL FIELD

The invention relates to the field of driver assistance systems for vehicles. In particular, the invention relates to a robust method for monitoring whether a vehicle guided by a driver assistance system has crossed the boundaries of the permissible driving zone when driving along a trajectory.

### BACKGROUND

Driver assistance systems for vehicles are generally known. Distance-based methods are also known that involve checking whether the vehicle, which is to be moved on a trajectory, maintains the predetermined distance from the boundaries of the driveable area along the entire movement path described by the trajectory. This is done taking into account the vehicle geometry, that is to say in particular the surface area created by projecting the vehicle body contour onto the road.

Methods are also known that involve checking whether a point of intersection arises between the driving corridor of the vehicle, that is to say the area covered by the projection of the vehicle body contour onto the road when the vehicle is moving along the trajectory, and the boundary lines of the driveable area, that is to say whether the driving corridor crosses a boundary of the driveable area. In known methods, the point of intersection with the boundary of the driveable area has to be computed.

The problem with the known methods is that they are very computationally intensive, since in each case systems of equations have to be solved in order to determine the distance of the vehicle from the boundary lines of the driveable area or the point of intersection of a section of the vehicle body contour with a boundary line. Moreover, it is not always possible to guarantee that the solution to the system of equations leads to real solutions. If no real solutions are found, a further check has to be carried out.

Document CN 1 02 295 004 A discloses a method for lane departure warning comprising the following steps: Providing the status information and the environmental information of the current vehicle motion by means of a vehicle sensor, a lane prediction by means of a driving behavior model of a human driver, predicting the possible lane region of a vehicle within a certain period of time in the future by combination with the vehicle kinematics and a kinetic model, having a lane departure warning decision, wherein a movement safety of the vehicle is analyzed by the relative relationship between the calculation time of a possible driving lane of the vehicle to a detection point range on the driving lane marking line and a preset threshold time is taken as an index of the lane deviation warning.

Document US 2012/0 212 612 A1 discloses a lane departure warning device for issuing a warning signal upon detection of a vehicle leaving a lane, wherein in the absence of lane markings the lane departure warning device estimates this.

Document KR 10 1 406 316 B1 teaches a device and a method for detecting lanes, wherein a warning zone within the lane is described on the basis of a detected lane. When the vehicle leaves this zone, a warning is issued.

The paper by Risack, R., N. Mohler, and W. Enkelmann “A video-based lane keeping assistant” Proceedings of the IEEE intelligent vehicles symposium 2000 (Cat. No. 00TH8511) teaches different methods of being able to detect a lane departure. One of these methods is the calculation of the “time to line crossing” based on the current trajectory and driving dynamics. Different driving dynamics models are used for the calculation, wherein the intersection points of the driving dynamics curve with the lane marking are calculated here.

### SUMMARY

Proceeding from this, an object of the present disclosure is to specify a method that makes it possible to reliably check whether a boundary of a driveable area has been crossed with low computational effort.

The object is addressed by a method having the features of independent patent claim 1. The subclaims relate to example embodiments. Coordinate patent claim 8 relates to a driver assistance system that is designed to check whether a boundary of a driveable area has been crossed.

According to a first aspect, what is disclosed is a method for checking whether a vehicle has crossed a boundary of a driveable area. The vehicle has a driver assistance system that is designed to move the vehicle along a trajectory in automated or partially automated fashion. The driver assistance system is additionally configured to perform the checking method, including the following steps.

Information about at least one boundary line of the driveable area is first received. Thus, the driveable area is defined in particular by the at least one boundary line, particularly by a left and a right boundary line, which are spaced apart from each other and define, for example, a lane. The information may be provided by an environment detection unit of the vehicle, which creates an environment model of the surroundings around the vehicle. By way of example, the boundary line may identify a boundary in free space, which in particular defines a lane on which the vehicle is to be moved. As an alternative, the boundary line may characterize a surrounding object in the environment of the vehicle.

The at least one boundary line may be defined by a multiplicity of points, that is to say by a polyline including multiple straight lines, wherein the straight lines each extend between two adjacent points. As an alternative, the boundary line may also be formed by a continuous line.

In addition, information about a driving corridor of the vehicle is received. The driving corridor is in particular the area that is covered by a projection of the vehicle body contour onto the road when driving along the trajectory. In other words, the driving corridor is in particular a tube-like area at least with a width equal to the vehicle width (also wider if a safety buffer is incorporated).

A first point and a second point on the at least one boundary line of the driveable area are selected. When information is received on two boundary lines, in particular on a left and right boundary line of the driveable area, a first point and second point may be selected on the two boundary lines, respectively. The first point in this case lies behind the second point on the same boundary line in the direction of travel of the vehicle. The points thus define a section of the at least one boundary line with respect to which the check as to whether or not the boundary line is crossed when driving along the trajectory is carried out.

At least or exactly one third point, lying on the edge of the driving corridor of the vehicle, is also identified. The driving corridor of the method may be defined either by continuous lines or else by a multiplicity of vehicle body contours positioned at different positions along the trajectory. The vehicle body contour may be formed, for example, by a polygon, in particular by a rectangle, which describes the vehicle body contour at least approximately when looking down onto the vehicle from above. The vehicle body contour may be selected to be larger than the actual vehicle body contour in order to obtain a safety buffer.

Then, at least intermittently, the position of the at least or exactly one third point relative to the line between the first and second points, which lie on the same boundary line, is ascertained, specifically by carrying out a rotation direction determination at least for the third point. It is further checked whether the determined direction of rotation is oriented clockwise or counterclockwise. In other words, the three points, two of which lie on the same boundary line and one of which indicates a point of the driving corridor of the vehicle, are connected by a polyline. The direction of rotation check is produced in particular if the polyline is traversed in such a way that the path between the two points on the boundary line of the driveable area is traversed in the direction of travel.

A next step is to check, based on the rotational direction checked of the at least third point, whether the vehicle has crossed the boundary of the driveable area.

The method has the technical advantage of enabling a technically simple check with little computational effort by virtue of the checking method based on the direction of rotation, since the checking method is point-based, meaning that it is possible to use computationally efficient vector calculation methods, and it is thus not necessary to solve a computationally intensive system of equations. In addition, the checking method makes it possible to identify whether the driveable area has already been completely left, which improves the safety of the checking method.

According to an exemplary embodiment, the rotation direction is determined by determining a rotation direction for the third point when traversing a polyline formed starting from the first point via the second point to the third point. Any mismatch between the determined direction of rotation and an expected direction of rotation indicates in particular that there is a boundary violation.

According to one example embodiment, the third point is a vehicle vertex of a polygon, in particular a quadrilateral, in particular a rectangle, which replicates the vehicle body contour of the vehicle. Thus, the vehicle body contour is approximated in particular by a rectangle with four corners.

According to one example embodiment, the at least or exactly one boundary line of the driveable area is approximated by multiple points spaced apart from each other, and point pairs of the boundary line are selected sequentially as first and second points and used for ascertaining the direction of rotation and checking whether the boundary of the driveable area has been crossed. This makes it possible to iteratively check whether the driveable area has been crossed based solely on pairs of points of the boundary line, without a system of equations.

According to one example embodiment, the driveable area has a left and a right boundary line that are spaced apart from one another and define a lane. The vehicle body contour is approximated by a polygon having two left vehicle vertices and two right vehicle vertices. The position of at least the two left vehicle vertices relative to the line between the first and second points that lie on the left boundary line is checked, at least intermittently for the left vehicle vertices. Furthermore, at least for the two left vehicle vertices, a rotation direction determination is carried out in each case, namely by determining a rotation direction for each left vehicle vertex when traversing a polyline, which is formed starting from the first point via the second point to the respective vehicle vertex. Thus, at least two rotation directions are determined in particular. It is then checked whether the determined directions of rotation are oriented clockwise. Based on the checked directions of rotation, it is checked whether the vehicle has crossed the left boundary line of the driveable area. The method is thus able to be applied advantageously and with reduced computational effort to achieving compliance with the left boundary line of a predefined lane.

According to one example embodiment, the driveable area has a left and a right boundary line that are spaced apart from one another and define a lane. The vehicle body contour is approximated by a polygon having two left vehicle vertices and two right vehicle vertices. The position relative to the line between the first and second points lying on the right boundary line is checked for the right vehicle vertices. Furthermore, for the two right vehicle vertices, a rotation direction determination is carried out in each case, namely by determining a rotation direction for each right vehicle vertex when traversing a polyline, which is formed starting from the first point via the second point to the respective vehicle vertex. Thus, at least two rotation directions are determined in particular. It is then checked whether the determined directions of rotation are oriented counterclockwise. Based on the checked directions of rotation, it is checked whether the vehicle has crossed the right boundary line of the driveable area. The method is thus able to be applied advantageously and with reduced computational effort to achieving compliance with the right boundary line of a predefined lane.

According to a further development, the rotation direction determination and the rotation direction checking are carried out for at least two vehicle vertices, particularly for all vehicle vertices, which replicate the vehicle body contour.

According to one example embodiment, the boundary line of the driveable area relates to a boundary line of a lane or road boundary.

A further subject of the present disclosure relates to a driver assistance system that is designed to check whether a vehicle has crossed a boundary of a driveable area. The driver assistance system includes multiple, in particular at least two, sensors arranged distributed around a vehicle, and a computing unit for processing the information provided by the sensors. The computing unit is configured to perform the following steps:
receiving information on at least one boundary line of the driveable area;
receiving information about a driving corridor of the vehicle, wherein the driving corridor is the area covered by a projection of the vehicle body contour onto the road when driving along the trajectory;
selecting a first and a second point on the at least one boundary line of the driveable area, wherein the first point lies behind the second point in the direction of travel of the vehicle;
defining at least or exactly one third point lying on the vehicle;
checking the position of at least the third point relative to the line between the first and second point, to verify that at least for the third point a rotation direction determination is carried out, and checking whether the determined direction of rotation is oriented clockwise or counterclockwise; and
ascertaining, on the basis of the verified rotation direction of the at least third point, whether the vehicle crosses the at least one boundary line of the driveable area.

For the purposes of the invention, the terms “approximately”, “substantially” or “about” mean deviations from the respective exact value by +/−10%, such as by +/−5%, and/or deviations in the form of changes insignificant for the function.

Developments, advantages and possible applications of the present disclosure also result from the following description of example embodiments and from the figures. In this case, all of the features described and/or illustrated are fundamentally the subject matter of the present disclosure, either in themselves or in any desired combination, irrespective of their combination in the claims or their back-reference. The content of the claims is also made part of the description.

### BRIEF DESCRIPTION OF THE DRAWINGS

The present disclosure will be explained in more detail below with reference to the figures using exemplary embodiments. In the figures:

FIG. 1 shows, by way of example, a schematic plan view of a vehicle having a driver assistance system comprising multiple sensors and a computing unit;

FIG. 2 shows, by way of example, different arrangements of points A, B, C which, with a given direction of revolution of the points, illustrates the resulting direction of rotation;

FIG. 3 shows, by way of example, the movement of a vehicle along a trajectory using a pair of boundary lines defining a lane and the exemplary application of the direction of rotation method for checking whether the boundary lines of the lane have been crossed;

FIG. 4 shows, by way of example, the movement of a vehicle based on a trajectory along a lane, wherein the left boundary line of the lane is crossed; and

FIG. 5 shows a flowchart illustrating the steps of the method for checking whether a boundary of a driveable area is crossed.

### DETAILED DESCRIPTION

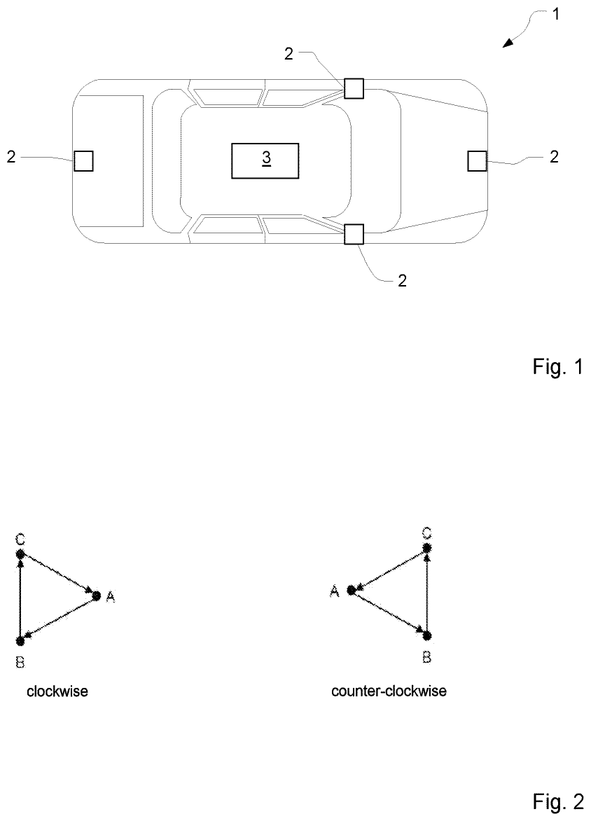

FIG. 1 shows, by way of example and schematically, a plan view of a vehicle 1 having a driver assistance system for carrying out automatic or partially automatic driving maneuvers. The driver assistance system may be designed in particular to recognize areas able to be driven automatically or partially automatically by the vehicle 1 and to control the vehicle 1 such that the vehicle does not cross any boundaries of the drivable area. By way of example, the driveable area may be a lane having a left and a right boundary line. As an alternative, the driveable area may be restricted by one or more surrounding objects with which a collision is to be avoided.

The vehicle 1 has multiple sensors 2, by way of which the surrounding area of the vehicle 1 is able to be detected. The sensors 2 are coupled to a computing unit 3 of the driver assistance system, which processes the sensor information and provides information about at least one boundary line of the driveable area. This surroundings detection gives the driver assistance system the ability to identify local areas over which the vehicle 1 is able to be guided without collision.

The driver assistance system is additionally designed to determine a trajectory on which the vehicle 1 is moved during the autonomous or partially autonomous driving maneuver. When driving through the trajectory, the vehicle is moved along a driving corridor. The driving corridor is given by the area that is covered or temporarily occupied by the vehicle body when the vehicle is moving. The vehicle has a circumferential vehicle body contour that results for example when looking down on the vehicle 1 from above, that is to say from a bird's eye view. The projection of this vehicle body contour vertically downwards onto the road defines the area of the road occupied by the vehicle 1. This area necessarily has to be free to be driven through in order to be able to move the vehicle 1 without collision. The driving corridor is thus tube-like and has a width at least equal to the width of the vehicle body contour. The driving corridor may also be designed to be wider than the vehicle width in order to increase the safety of the method.

In order to identify whether the vehicle 1 crosses a boundary of the driveable area, it is possible to apply a direction of rotation-based checking method.

FIG. 2 shows two possibilities as to how a trio of points A, B and C may be arranged.

By way of example, the line between the first and second points B and C forms a section of a boundary line of the driveable area. By way of example, the third point A may be a vertex of the vehicle body contour of the vehicle 1. Points A, B, and C span a triangle, generally a polygon. When traversing the polyline along the points in a predefined sequence, for example from point B to point A going via point C, it is possible to ascertain position information regarding point A relative to the line between points B and C. If a clockwise direction of rotation results when traversing the polyline, it may be concluded that point A lies to the right of the line BC. In the opposite case, it may be concluded that point A lies to the left of the line BC if a direction of rotation results counterclockwise when traversing the polyline (right-hand illustration in FIG. 2).

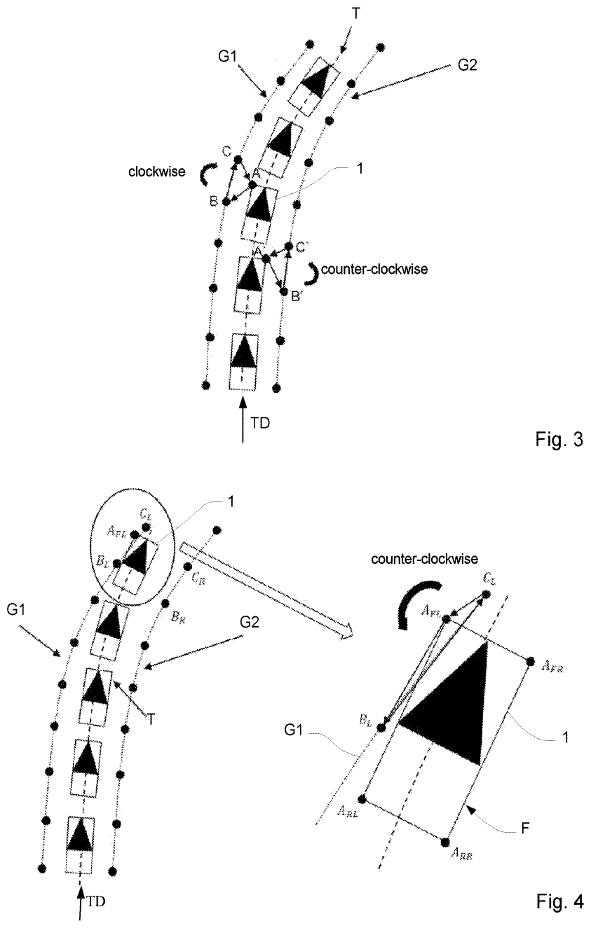

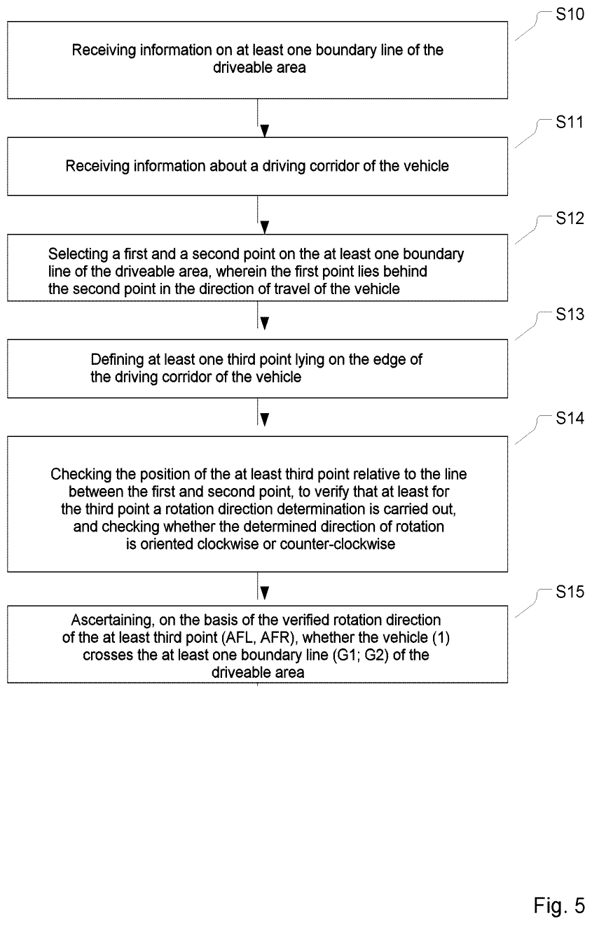

FIG. 3 shows one exemplary application of the described method, in which the vehicle 1 is moved on a trajectory T in the direction of travel TD on a lane defined by a left boundary line G1 and a right boundary line G2. The boundary lines G1, G2 may be replicated by discrete points spaced apart from one another. In the example embodiment according to FIG. 3, points B and C are two points of the left boundary line G1 and points B′ and C′ are two points of the right boundary line G2.

The vehicle body contour of the vehicle 1 is replicated by a rectangle. The size of the rectangle is selected such that all areas of the vehicle 1 lie within this vehicle body contour, for example including the side mirrors of the vehicle 1.

In order to ensure that the vehicle 1 is able to be moved without collision along the trajectory T, it is necessary to check that the driving corridor of the vehicle 1, resulting from the movement of the vehicle body contour along the trajectory T, does not have any point of intersection with the boundary lines G1, G2. The driving corridor of the vehicle 1 may in particular be a tube-like area that must lie within the boundary lines G1, G2 in order to guarantee that the trajectory T is free from collisions.

The check as to whether the trajectory T is free from collisions may be carried out iteratively based on discrete vehicle positions of the vehicle 1, as indicated in FIG. 3 by the multiplicity of rectangles representing the vehicle 1.

At a defined vehicle position, it must be checked whether the left vehicle contour line is located to the right of the left boundary line G1 and whether the right vehicle contour line is located to the left of the right boundary line G2. This test may be carried out, in the example embodiment shown, based on front left and rear left corners, or the front right and rear right corners. It is necessary to check in more detail whether the front left and rear left corners have the same position in relation to the left boundary line G1, that is to say both lie to the right of the left boundary line G1. The same applies to the front right and rear right corners in relation to the right boundary line G2. These two corners must also have the same position relative to the right boundary line G2, that is to say both must lie to the left of the right boundary line G2.

By way of example, this check involves determining a pair of points of the left boundary line G1 of the lane that is close to the left vehicle contour line. In the example embodiment shown, these are points B and C. The front left corner of the vehicle 1 is denoted point A. For the polyline including the sequence of points B-C-A, this results in a clockwise direction of rotation.

The same check is then performed for the rear left corner of vehicle 1 relative to points B and C. If the polygon polyline is traversed from point B to C back to B going via the rear left corner, this also results in a clockwise direction of rotation. The result of the check is thus that both vertices of the left vehicle contour line lie on the same side of the left boundary line G1, that is to say the left vehicle contour line does not intersect the left boundary line G1, that is to say there is no collision with the left boundary line G1. It may additionally be identified that both vertices of the left vehicle contour line lie to the right of the left boundary line G1.

A similar check is carried out with regard to the two vertices of the right vehicle contour line relative to the right boundary line G2.

As shown in FIG. 3, the right boundary line G2 is also represented by a multiplicity of points, wherein points B′ and C′ define a line that forms a portion of the right boundary line G2. In order to be able to identify whether the vehicle 1 does not cross this right boundary line G2 when driving through the driving corridor, the algorithm described above is implemented analogously for the vertices of the right vehicle contour line. The direction of rotation is thus determined for the front right corner of the vehicle contour line A′ and the resulting polyline B′-C′-A′, this direction of rotation resulting when the polygon polyline is traversed in the direction of travel described above. This is counterclockwise in the exemplary embodiment shown.

A similar check is then performed for the rear right corner of vehicle 1 relative to points B′ and C′. If the polygon polyline is traversed from point B′ to C′ back to B′ going via the rear right corner of the vehicle 1, this also results in a counterclockwise direction of rotation. The result of the check is thus that both vertices of the right vehicle contour line lie on the same side of the right boundary line G2, that is to say the right vehicle contour line does not intersect the right boundary line G2 and there is thus no collision with the right boundary line G2. It may additionally be identified that both vertices of the right vehicle contour line lie to the left of the right boundary line G2.

The checking steps described above may be performed iteratively for multiple vehicle positions along the driving corridor and for different sections (defined by pairs of points B-C or B′-C′) of the boundary lines G1 and G2 in order to guarantee that the trajectory T is free from collisions.

FIG. 4 shows an example in which the trajectory T is determined such that the driving corridor of the vehicle 1 intersects the left boundary line G1 in the area marked with the oval, and a boundary of the driveable area is thus crossed.

Any mismatch with the expected direction of rotation indicates in particular that there is a boundary violation. In this exemplary embodiment, the expected rotational directions for the polyline of the respective vehicle vertices A_{FL}, A_{RL}, A_{FR}, A_{RR} are as follows:

| Ordered sequence of points of the | |
|---|---|
| polyline | Expected rotation direction |
| (front left vehicle vertex A_{FL}, B_{L}, C_{L}) | Clockwise |
| (rear left vehicle vertex A_{RL}, B_{L}, C_{L}) | Clockwise |
| (front right vehicle vertex A_{FR}, B_{R}, C_{R}) | Counter-clockwise |
| (rear right vehicle vertex A_{RR}, B_{R}, C_{R}) | Counter-clockwise |

The section of the boundary line G1 in the region of the vehicle 1 is defined by points B_{L} and C_{L}. The front left corner of the vehicle 1 is referred to as point A_{FL}. For the polyline having the sequence of points B_{L}-C_{L}-A_{FL}, this results in a direction of rotation counterclockwise. When applying the proposed method to the rear left corner of vehicle 1, denoted point A_{RL}, with respect to the boundary line G1, which in turn is defined by points B_{L} und C_{L}, this results in a clockwise direction of rotation when traversing the polyline along points B_{L}-C_{L}-A_{RL}. Since the directions of rotation for the front and rear corners are different, the proposed method makes it possible to recognize crossing of the boundary line G1.

In order to recognize that the vehicle 1 does not lie completely outside the drivable area, it may be useful to check, in each cycle or at longer time intervals, the position of the left or right pairs of corners of the vehicle contour line relative to at least one boundary line G1, G2. In the event for example that a counterclockwise direction of rotation results for the left corners of the vehicle contour line of the vehicle 1 relative to the line identified by points B_{L} and C_{L} and this direction of rotation indicates that the left corners of the vehicle body contour lie to the left of the left boundary line G1, it may be concluded from this that the vehicle 1 is already located outside the driveable area at this point of the trajectory T and the boundary of the driveable area has thus been crossed.

### LIST OF REFERENCE SIGNS

1 vehicle
2 sensor
3 computing unit
B first point
C second point
A_{FL}, A_{FL}, A_{FR}, A_{LR}, A_{RR} third point
F vehicle body contour
TD direction of travel
G1 left boundary line
G2 right boundary line
T trajectory

1. A computer-implemented method for monitoring whether a vehicle traveling along a trajectory has crossed a boundary of a driveable area, the method comprising:
a) receiving, by computer hardware, information on at least one boundary line of the driveable area;
b) receiving, by the computer hardware, information on a driving corridor of the vehicle;
c) selecting, by the computer hardware, a first point and a second point on the at least one boundary line of the driveable area, wherein the first point is behind the second point in a direction of travel of the vehicle;
d) defining, by the computer hardware, at least one third point which is located on an edge of the driving corridor of the vehicle;
e) checking, by the computer hardware, a position of the at least third point relative to a line between the first point and the second point, to check that at least for the at least one third point a rotation direction determination is carried out and to checked whether the determined rotation direction is oriented clockwise or counterclockwise;
f) ascertaining, by the computer hardware on the basis of the checked rotation direction of the at least one third point, whether the vehicle crosses the at least one boundary line of the driveable area; and
g) controlling the vehicle based upon the ascertaining.

2. The method as claimed in claim 1, wherein the determination of the rotation direction is carried out by determining a rotation direction for the at least one third point when traversing a polyline formed from the first point via the second point to the at least one third point.

3. The method as claimed in claim 1, wherein the at least one boundary line of the driveable area is approximated by multiple points spaced apart from each other, and point pairs of the boundary line are selected sequentially as the first and second points and used for ascertaining the rotation direction and the check as to whether the boundary of the driveable area has been crossed.

4. The method as claimed in claim 1, wherein the at least one third point is a vehicle vertex of a polygon that replicates a vehicle body contour of the vehicle.

5. The method as claimed in claim 4, wherein
the driveable area has a left boundary line and a right boundary line, which are spaced apart from each other and define a driving lane,
the vehicle body contour is approximated by a polygon with two left vertices and two right vehicle vertices, and
a position of at least two left corners relative to the line between the first and second points, located on the left boundary line, is checked at least intermittently, at least for the two left vehicle vertices, a direction of rotation is determined in each case; by determining a direction of rotation for each left vehicle vertex when traversing a polyline formed starting from the first point via the second point to the respective vehicle vertex, and it is checked whether the two directions of rotation are oriented clockwise.

6. The method as claimed in claim 4, wherein the driveable area has a left boundary line and a right boundary line, which are spaced apart from each other and define a driving lane, wherein the vehicle body contour is approximated by a polygon with two left vehicle vertices and two right vehicle vertices, wherein a position of the two right vehicle vertices relative to the line between the first point and second point, located on the right boundary line is checked at least intermittently, wherein for the two right vehicle vertices, a direction of rotation is determined in each case by determining a direction of rotation for each right vehicle vertex when traversing a polyline formed starting from the first point via the second point to the respective vehicle vertex, and wherein it is checked whether the two directions of rotation are oriented counterclockwise.

7. The method as claimed in claim 4, wherein the rotation direction determination and rotation direction monitoring are carried out for all vehicle vertices that reproduce the vehicle body contour.

8. A driver assistance system configured to check whether a vehicle has crossed a boundary of a driveable area, wherein the driver assistance system comprises:
multiple sensors arranged and distributed around a vehicle; and
a computing unit communicatively coupled to the sensors for processing the information provided by the sensors, wherein the computing unit is configured to perform:
a) receiving information on at least one boundary line of the driveable area;
b) receiving information on a driving corridor of the vehicle, wherein the driving corridor is a zone covered by a projection of the vehicle body contour onto a road when driving along a trajectory;
c) selecting a first point and a second point on the at least one boundary line of the driveable area, wherein the first point is behind the second point in a direction of travel of the vehicle;
d) defining a third point which is located on an edge of the driving corridor of the vehicle;
e) checking a position of the third point relative to a line between the first and second points, to verify that at least for the third point a rotation direction determination is carried out, and verifying whether the determined direction of rotation is oriented clockwise or counterclockwise;
f) ascertaining, on the basis of the verified rotation direction of the third point, whether the vehicle crosses the at least one boundary line of the driveable area; and
g) controlling the vehicle based on the ascertaining.
